(19) United States
(12) Patent Application Publication
(10) Pub. No.: US 2020/0045393 A1
(43) Pub. Date: Feb. 6, 2020

(54) SPEAKER BOX

(71) Applicant: AAC Technologies Pte. Ltd., Singapore city (SG)

(72) Inventors: Jun Wu, Shenzhen (CN); Kaihua Shen, Shenzhen (CN); Yue Ren, Shenzhen (CN)

(21) Appl. No.: 16/525,572

(22) Filed: Jul. 30, 2019

(30) Foreign Application Priority Data
Aug. 2, 2018 (CN) 201810873714.1

(51) Int. Cl. H04R 1/02

(52) U.S. Cl. CPC H04R 1/02; H04R 2499/11

(57) ABSTRACT

The present disclosure provides a speaker box which comprises a shell having a receiving space, a speaker, a support wall, and a sound guiding channel. The speaker is fixedly supported on the support wall. The speaker comprises a diaphragm, the diaphragm partitions the receiving space into a front sound cavity and a rear cavity. The sound guiding channel communicates the front sound cavity with the outside and forms a front cavity with the front sound cavity. The speaker box also includes a surrounding wall and a cover plate. The surrounding wall is located on the outside of the support wall, and the shell, surrounding wall, support wall and cover plate are jointly enclosed as auxiliary vocal cavity. The support wall is provided with a through hole, and the auxiliary vocal cavity is communicated with the front cavity through the through hole to form the resonant cavity structure of the front cavity.

### FIELD OF THE DISCLOSURE

The present disclosure relates to acoustic-electro transducers, and more particularly to a speaker box used in a portable electronic device.

### DESCRIPTION OF RELATED ART

With the arrival of the mobile internet era, the number of smart mobile devices is being increasing. However, in all these mobile devices, mobile phones are the most common and portable mobile terminal deices. At present, mobile phones are powerful functionality, and one of the powerful functions is the high-quality music function. Therefore, speaker boxes for playing music are widely applied to conventional smart mobile devices.

A speaker box of the related art comprises a shell having a receiving space, a speaker accommodated in the shell and a sound guiding channel defined in the receiving space. The speaker comprises a diaphragm for vibration and produce sound via irradiation, the diaphragm partitions the receiving space into a front sound cavity and a rear cavity. The sound guiding channel communicates the front sound cavity with the outside, and cooperatively defines a front cavity with the front sound cavity.

However, in the speaker box of the related art, the space of the front cavity is limited to a region rightly opposite to a dome and a region of the sound guiding channel, and the structure is monotonous and may not be optimized. Therefore, high-frequency acoustic performance of the speaker box is subject to restrictions, and over-high high-frequency responses may cause harsh sounds, sharp dentilabial sounds and the like poor sound effects.

Therefore, it is desired to provide a speaker box to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a three-dimensional structure of the speaker box in accordance with an exemplary embodiment of the present disclosure;

FIG. 2 is a schematic diagram exploded view of a portion of the three-dimensional structure of the speaker box showing in FIG. 1;

FIG. 3 is a cross-sectional view along the A-A line showing in FIG. 1;

FIG. 4 is a frequency response graph of a speaker box of the related art; and

FIG. 5 is a graph showing the frequency response of different embodiments of the speaker box of the present disclosure by adjusting the number and the location of resonant cavities.

### DETAILED DESCRIPTION

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

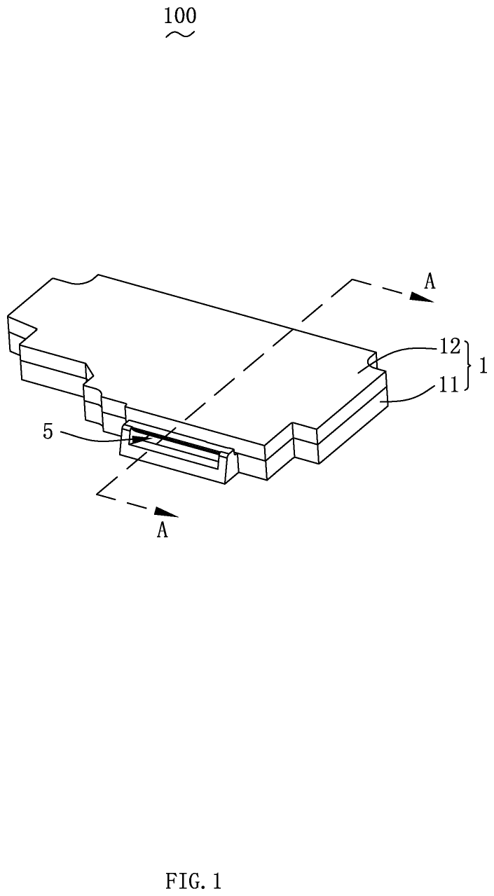

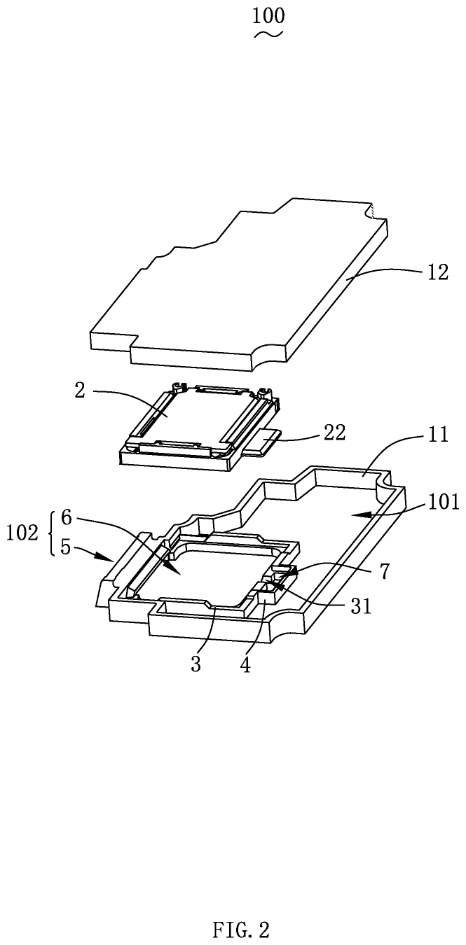

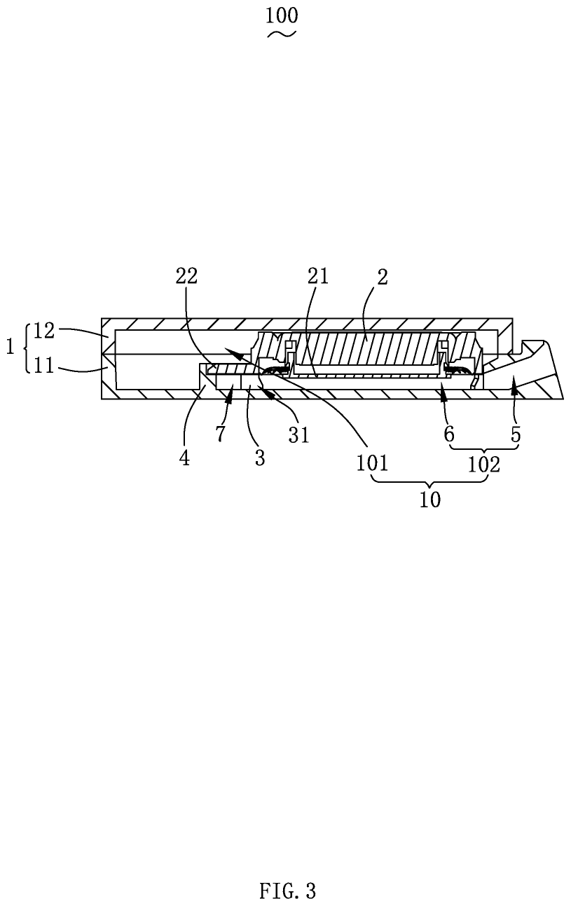

Please also refer to FIG. 1 to FIG. 3, wherein FIG. 1 is a three-dimensional structure diagram of the speaker box of the present disclosure, FIG. 2 is a exploded view schematic diagram of a partial three-dimensional structure of the speaker box showing in FIG. 1, and FIG. 3 is a cross-sectional view along the A-A line showing in FIG. 1.

The present disclosure provides a speaker box 100, which comprises a shell 1 having a receiving space 10 and a speaker 2.

The shell 1 comprises a support wall 3, a surrounding wall 4 and a sound guiding channel 5. The support wall 3 and the surrounding wall 4 are disposed in the inner of the shell 1 and are formed by the inner extension of the shell 1. The surrounding wall 4 is located on the outside of the support wall 3.

The shell 1 may be formed integrally or be formed separately. For example, in this embodiment, the housing 1 includes an upper cover 11, and a lower cover 12 covering with the upper cover 11 and cooperatively defining the receiving space 10 with the upper cover 11.

The speaker 2 is accommodated in the receiving space 10 of the Shell 1, and the speaker 2 partitions the receiving space 10 into a front sound cavity 6 and a rear cavity 101.

In this embodiment, the speaker 2 is fixed to the support wall 3, and is supported by the support wall 3. The speaker 2 and the upper cover 11 are spaced apart each other to define the front sound cavity 6.

The speaker 2 comprises a diaphragm 21 for vibration and producing sound via irradiation, and the diaphragm 21 partitions the receiving space 10 into the front sound cavity 6 and the rear cavity 101. In particular, the diaphragm 21 is spaced apart with the upper cover 11, and cooperates with the upper cover 11 to form the front sound cavity 6. The diaphragm 21, the lower cover 12 and the upper cover 11 cooperatively define the rear cavity 101 together. The rear cavity 101 is used to improve the low frequency acoustic performance of the speaker box 100.

The sound guiding channel 5 is formed in the receiving space 10. In this embodiment, the sound guiding channel 5 is formed in the upper cover 11. The sound guiding channel 5 communicates the front sound cavity 6 with the outside, and the sound guiding channel 5 is cooperates together with the interior vocal cavity 6 to form the interior cavity 102. The sound guiding channel 5 is used to form a side vocal structure of the interior cavity 102.

The support wall 3 is for supporting and fixing the speaker 2. The support wall 3 and the surrounding wall 4 are disposed on the upper cover 11. There is a cover plate 22 extending from the speaker 2.

Specifically, the cover plate 22 completely covers the surrounding wall 4. The shell 1, the support wall 3, the surrounding wall 4 and the cover plate 22 jointly enclosed as an auxiliary acoustic cavity 7. The support wall 3 is provided with a through hole 31 therethrough, and the auxiliary acoustic cavity 7 is communicated with the front cavity 102 by the through hole 31 to define the resonant cavity structure of the front cavity 102, which is used to improve the acoustic performance of high frequency acoustics. On the one hand, the structure effectively increases the cavity volume of the front cavity 102, improves the high-frequency acoustic performance, on the other hand, the surrounding wall 4 structure design is more flexible and diverse, less restrictive, and more applicable.

More preferably, the cover plate 22 is made of a PET, which can effectively reduce the resonance peak and distortion of the resonant cavity, thereby making the high-frequency acoustic performance better. Of course, the material of the cover plate is not limited thereto, as long as it can be effective. The principle is the same for a cover plate made of other materials that reduces the resonance peak and distortion of the resonant cavity.

In the present embodiment, the surrounding wall 4 is communicated with the front sound cavity 6 through the through hole 31. Of course, the auxiliary acoustic cavity 7 can also be communicated with the sound guiding channel 5 through the through hole 31, which is also feasible, and the principle is the same.

Specifically, the speaker 2 is fixed to the support wall 3 by glue bonding, the joint between the cover plate 22 and the surrounding wall 4 is glued to improve the airtightness of the front cavity 102 and the auxiliary acoustic cavity 7, so that the high frequency acoustic performance is better.

More preferably, one or more of the surrounding wall 4 may be provided, what's more, a plurality of positions of the surrounding wall 4 may be provided too. In the present embodiment, the surrounding wall 4 is provided with one. According to the requirement of acoustic performance adjustment, a plurality of resonant cavities may be formed by increasing the number of surrounding walls and the number of cover plates corresponding to the surrounding wall 4 to increase the volume of the resonant cavity of the front cavity, or by adjusting the position of the surrounding wall to improve high frequency acoustic performance.

In the present embodiment, the through hole 31 has at least one of a rectangular shape, a triangular shape, and a circular shape. Of course, the shape thereof is not limited thereto. The number of the through holes 31 is also not limited and may be one or more.

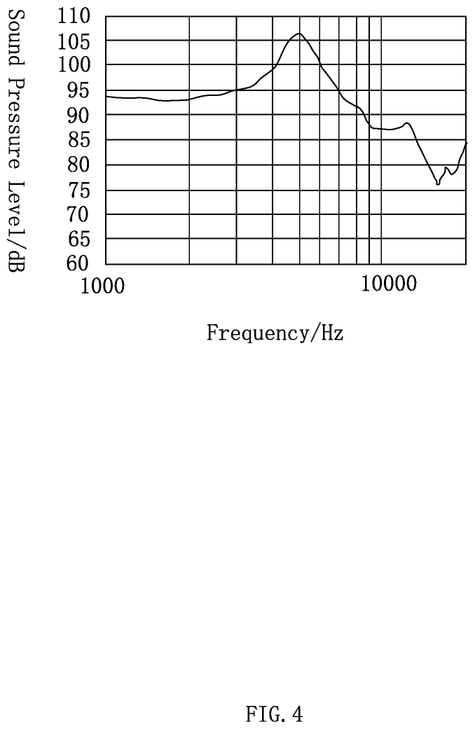

Please refer to FIG. 4, FIG. 4 is a frequency response graph of a speaker box of the related art. When the operating frequency of the speaker box of the related art is at the level of 4000˜6000 Hz, the sound pressure level of the speaker box is greater than 100 dB. When it reaches 5000 Hz, the sound pressure level of the speaker box reaches a peak with a peak value greater than 106 dB. According to the chart analysis, when the working frequency is at the level of 4000˜6000 Hz, the sound pressure level of the speaker box is high, and the actual listening high frequency is harsh, especially the lip tooth sound is sharp, and the high frequency acoustic performance is poor.

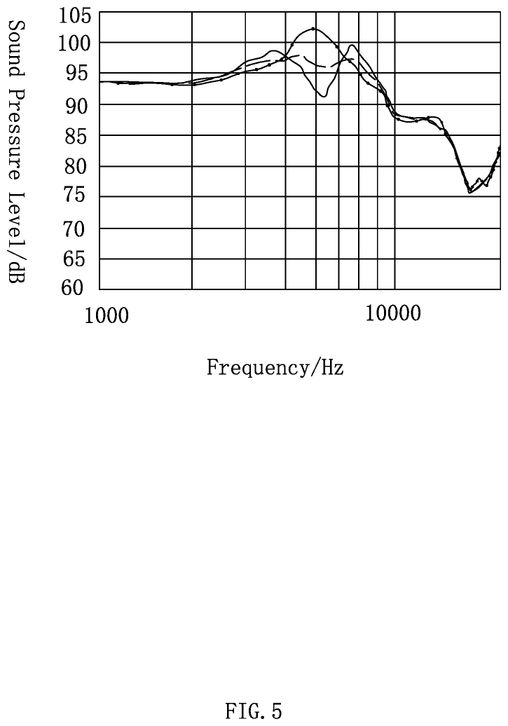

Please refer to FIG. 5, wherein the FIG. 5 is a graph showing the frequency response of different embodiments of the speaker box of the present disclosure by adjusting the number and the location of resonant cavities. When the operating frequency is at the level of 4000˜6000 Hz, the sound pressure level corresponding to the frequency response curve of the speaker box of the three different embodiments of the speaker box of the present invention is compared with the frequency response curve of the speaker box of the related art shown in FIG. Reduced and peaked. In one embodiment, the speaker box has the highest peak frequency response curve. When the operating frequency is 5000 Hz, the peak corresponding to the sound pressure level is less than 102 dB. In summary, the speaker box of the present invention effectively improves high frequency acoustic performance.

Compared with the relevant art, the speaker box 100 of the present invention forms an auxiliary acoustic cavity 4 connecting with the interior cavity 102 in the shell 11, so that the auxiliary acoustic cavity 4 performs as a part of the interior cavity 102 and acts as a resonant cavity, on the one hand, the aforementioned structure effectively increases the volume of the cavity of the interior cavity, and improves High-frequency acoustic performance, on the other hand, the auxiliary acoustic cavity structure design is more flexible and diverse, and the applicability is higher. The above structure can effectively reduce the Q value (quality factor value) and sensitivity of the high-frequency resonance peak of the speaker box, so that the acoustic performance of the speaker box better.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A speaker box, comprising:
a shell having a receiving space;
a support wall, which is formed by extending from the inner side of the shell;
a speaker, which is accommodated in the receiving space of the shell and is fixed and supported by the support wall, the speaker comprises a diaphragm for producing sound via vibration, the diaphragm partitions the receiving space into a front sound cavity and a rear cavity;
a sound guiding channel, which is formed in the receiving space and communicates the front sound cavity with the outside and cooperates with the front sound cavity to form a front cavity;
a surrounding wall, which is formed by extending from the inner side of the shell and is located outside the support wall;
a cover plate, which is formed by extending from the speaker toward the outside and covers the surrounding wall, and the shell, the surrounding wall, the support wall and the cover plate collectively enclose as a auxiliary acoustic cavity;
wherein the support wall comprises a through hole penetrating therethrough, and the auxiliary acoustic cavity communicates with the front cavity through the through hole to form a resonant cavity structure of the front cavity.

2. The speaker box as described in claim 1, wherein the shell comprises an upper cover and a lower cover, the upper cover and the lower cover form a receiving space, the support wall and the surrounding wall are formed on the upper cover, and the speaker is supported on the support wall and cooperatively defines the front sound cavity with the upper cover.

3. The speaker box as described in claim 1, wherein the speaker is fixed to the support wall by glue bonding, and a sealing seal formed between the cover plate and the surrounding wall.

4. The speaker box as described in claim 1, wherein the through hole has at least one of a rectangular shape, a triangular shape, and a circular shape.

5. The speaker box as described in claim 1, wherein the cover plate is made of PET material.

6. The speaker box as described in claim 1, wherein the auxiliary acoustic cavity is communicated with the front sound cavity through the through hole.
